(19) United States
(12) Patent Application Publication
(10) Pub. No.: US 2012/0106804 A1
(43) Pub. Date: May 3, 2012

(54) METHOD FOR DETERMINING THE RECOVERY GRADE IN ARTIFICIAL FIBER CARPETS

(75) Inventors: Margarita Canales Compes, Zaragoza (ES); Miguel Angel Jimenez Caballero, Zaragoza (ES); Cristina Gomez Andres, Zaragoza (ES); Emanuel Testa, Zaragoza (ES)

(73) Assignee: MONDO S.P.A., Alba. Frazione Gallo (Cuneo) (IT)

(21) Appl. No.: 13/266,177

(22) PCT Filed: Apr. 21, 2010
(86) PCT No.: PCT/IB2010/051748

§ 371 Date: Jan. 12, 2012

(30) Foreign Application Priority Data
Apr. 28, 2009 (ES) 200930107

(51) Int. Cl. G06K 9/00

(52) U.S. Cl. 382/111

(57) ABSTRACT

A method for determining the recovery grade in artificial fiber carpets, such as artificial turf, including obtaining samples of the artificial fiber carpets to be examined in order to capture an image, by a camera and lightbulb under conditions of controlled exposure, of the area of the fibers which will subsequently be subjected to supporting a load. In a certain area of the fibers, in a vertical compressive manner, a load of known mass during a predetermined time is applied, for once the load is released, capturing elevational images, according to the same area of the fibers subjected to the load, at predetermined time intervals. The recovery index of the fibers subjected to analysis based on the area occupied by the fibers is determined before being subjected to the load and after the different predetermined time intervals.

### OBJECT OF THE INVENTION

The following invention, according to what is expressed in the statement of the present specification, relates to a method for determining the recovery grade in artificial fiber carpets, being of the type of carpets manufactured by weaving artificial fibers, which are of special use in obtaining carpets for artificial turf.

The object of the invention is to be able to determine the recovery index of the artificial fibers making up the turf, i.e. the capability of recovery and return to its vertical position defined in the manufacture of the carpet.

### FIELD OF APPLICATION

In the present specification, a method (for determining the recovery grade of artificial fibers) is described, being of special application for determining the recovery grade in fiber carpets for artificial turf.

Likewise, the method being described is equally applicable in artificial fibers destined for other uses.

### BACKGROUND OF THE INVENTION

In the absence of an objective qualitative method for determining the recovery grade of artificial fibers, to date, the analysis of the recovery of the fibers in artificial turf carpets has been carried out by means of a subjective method based on the following characteristics:
Applying a weight over the turf moquette, of approximately 25 kg, during a period of 20 hrs.
After that time has elapsed, photographs are captured, according to a “plan” view under conditions of uncontrolled exposure, at various time intervals once the load is released; i.e. after 1 minute, after 10 minutes, after 1 hour, and lastly after 7 hours of the artificial turf carpet being released from the aforementioned weight.

For each time interval, by the visual observation by a technician, images corresponding to different materials are compared, and the carpet, on which the mark of the weight with which it has been loaded is observed more, is discriminated. As indicator of the recovery, a greater mark is considered to be equivalent to a lower recovery, and therefore to a greater remaining deformation. This method, besides being subjective, is qualitative, since said mark is not parameterized (not measured).

In the absence of an objective and analytic method that allows obtaining a quantitative parameter with which to compare the recovery behavior of different materials, the test methodology described in the present document has been developed.

### DESCRIPTION OF THE INVENTION

It is described in the present specification a method for determining the recovery grade in artificial fiber carpets, mainly, artificial turf carpets, with a method consisting of:
1 obtaining the samples to be examined from the artificial fiber carpets;
2 positioning the samples in a specific position (“elevational” or “profile” view, not in “plant”);
3 fixed positioning of a camera and lightbulb;
4 capturing an “elevational” image of the area of the fibers which subsequently will be subjected to supporting a load;
5 applying in a certain area of the fibers, in a vertical compressive manner, a known mass load during a predetermined time;
6 once the load is released, images are captured, according to an “elevational” view under conditions of controlled exposure, according to the same area, of the fibers subjected to the load, at predetermined time intervals;
7 treating the captured images, framing the same zone of application of the load;
8 carrying out a balance on the images increasing the contrast of the image defining the two zones of study relative to the fibers zone and to the background present in a different color;
9 eliminating all the glossiness from the fibers appearing in the background image;
10 the images treated in the previous three stages, for each time interval, are analyzed obtaining the area, in mm², of each one of the two stages depicted in a different color, and;
11 determining the recovery index of the fibers subjected to an analysis based on the area occupied by the fibers before being subjected to the load and after the different predetermined time intervals, said index being determined by:

$$Recovery index ( \% ) , {I}_{t} = \frac{Area after releasing load ( {mm}^{2} )}{Area without load ( {mm}^{2} )} \times 100$$

where t=0, . . . , k are the predetermined time intervals.
12 determining the recovery rate of the fibers subjected to an analysis for which the curve of the recovery index is adjusted to a logarithmic mathematical function of the type
f(x)=Aln(x)+B, as the function derivative (the slope) at the moment of releasing the load, the function being:

$${I}_{t} \approx A \cdot Ln ( t ) + B$$

$${V}_{R} ( t = 1 min ) = \frac{d ( {I}_{t} )}{d t} = A \cdot 1 / t ( \% \text{/} min )$$

By means of the methodology, obtained in “elevation”, of vertically applying load and the subsequent image treatment, two objective and quantifiable parameters have been achieved of the grade and speed of recovery of the fibers of the artificial turf carpets respectively called “index and rate of recovery”.

In this manner, the results from each image captured, at the different predetermined time intervals, allow obtaining how much and how fast the various materials recover after being processed as artificial fibers sewn on a polymeric fabric such as, e.g. the artificial turf.

For supplementing the description to be carried out next, and with the object to aid to a better understanding of the characteristics of the invention, a set of figures are attached to the present specification which describe in a illustrative but not limitative manner, the most characteristic details of the invention are depicted.

### BRIEF DESCRIPTION OF THE DESIGNS

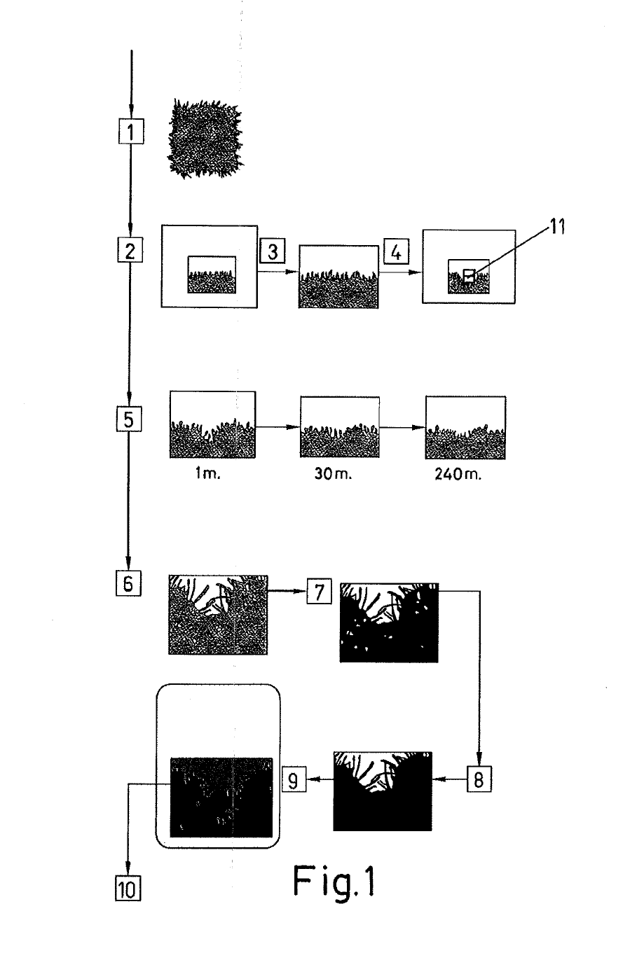

FIG. 1.—Shows a view of the test methodology followed in order to determine the recovery grade of the fibers in carpets for artificial turf.

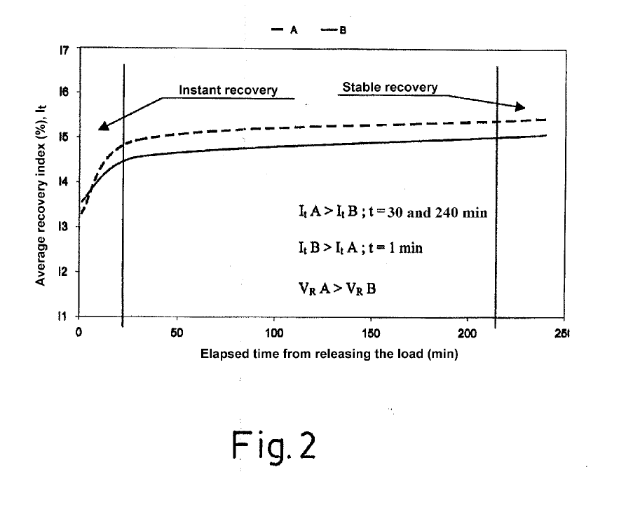

FIG. 2.—Depicts a graph of the evolution of the recovery index, Iₜ of two materials A and B along the elapsed time from the release of the load of the corresponding sample.

### DESCRIPTION OF A PREFERRED EMBODIMENT

In view of the commented figures and according to the adopted numbering, we can observe how in the first place the samples 1 of artificial turf should be obtained, which are to be examined from the manufactured carpet rolls, the samples can present different measurements.

Once the samples to be examined are obtained, they should be framed in a same position 2 with the object to capture “elevational” images of a same area, such that for that purpose a frame is arranged, of for example 160×120 mm², with graph paper adhered thereto, allowing controlling the examination area.

In the same way, with the object for the images capture to be made from a same area, the position of the camera for image capture and of the lightbulb is also attached and maintained which will allow obtaining a clear and sharp image under conditions of controlled exposure.

In this manner, the different samples to be examined will be framed in the frame capturing the image 3 of the area relative to the fibers which should subsequently support the load, being able to define the total area occupied by the fibers, corresponding to 100% of the fibers in state of equilibrium.

Subsequently in stage 4, over the different samples 1 a compression load 11 is vertically applied, of for example 1856 kg, during a predetermined time, for example, 72 hours.

Elapsed said time, the load 11 is released, proceeding to capture the corresponding images 5 after some predetermined time intervals, such as 1, 30 and 240 minutes, of the zone which has supported the load.

In the following stage 6, the images captured with the camera will be treated with the object to frame the zone of application of the load in each one of them by the dimensions defined in the frame.

Subsequently, optionally, a balance 7 of the images can be carried out increasing the image contrast defining the two zones of study relative to the fibers zone (black zone), and to the background zone (white zone).

In the same way, optionally, a following stage 8 could exist wherein the glossiness of the fibers appearing in the background image is eliminated.

The images treated in stage 6, or after the aforementioned optional stages 7 and 8, if they have been carried out, are analyzed at each time interval (1, 30 and 240 minutes) in a following stage 9 obtaining the area, in mm², of each one of the two zones depicted in a different color.

Finally, in a last stage 10, the recovery index (Iₜ) of the fibers subjected to analysis will be determined based on the area occupied by the fibers before being subjected to the load and after the different predetermined time intervals, said index being determined by:

$$Recovery index ( \% ) , {I}_{t} = \frac{Area after releasing load ( {mm}^{2} )}{Area without load ( {mm}^{2} )} \times 100$$

where t=0, . . . , k are the predetermined time intervals, different recovery indexes being obtained, therefore, according to the time interval considered after releasing the load.

For example, in FIG. 2 of the designs for any two materials A and B, IA>IB for t=30 and 240 minutes; while for t=1 minute, IB>IA.

As for the recovery rate V_{R}, expressed in recovery percentage by time (%/min), it can be indicated that:

in order to calculate this parameter, the experimental curve “It versus t” should be adjusted to a mathematical function with an acceptable regression (for example, R²>0.90). In this case, the function that better describes the experimental data of “recovery index” is a logarithmic function of the type f(x)=Aln(x)+B, with the objective to calculate the recovery rate as the function derivative (the slope) just at the initial moment of releasing the load (t=1 min) as shown in FIG. 2 of the designs.

$${I}_{t} \approx A \cdot Ln ( t ) + B$$

$${V}_{R} ( t = 1 min ) = \frac{d ( {I}_{t} )}{d t} = A \cdot 1 / t ( \% \text{/} min )$$

In this manner, for example, for any two materials A and B shown in FIG. 2, the material A shows a recovery rate higher than the material B (V_{R} A>V_{R} B).

Therefore, a second quantitative parameter has been obtained which informs about the speed with which a material recovers as soon as the load is released.

Optionally, with the images treated and framed in the same zone of application of the load, a balance of the images can be carried out increasing the contrast of the image defining the two zones of study relative to the zone of fibers and background present in a different color and to eliminate all glossiness from the fibers appearing in the background image.

Definitely, the results from each captured image, at the different predetermined time intervals, allow obtaining how much and how fast various materials recover after being processed as artificial fibers sewn on a polymeric fabric, as is the case of artificial turf.

1. A method for determining the recovery grade in artificial fiber carpets, being of the type of carpets manufactured by means of weaving artificial fibers for obtaining artificial turf, comprising:
obtaining samples from artificial fiber carpets to be examined;
positioning the samples in a specific position of elevational view;
fixed positioning of a camera and lightbulb under conditions of controlled exposure;
capturing an image of the area of the fibers which subsequently will be subjected to supporting a load;
applying in a certain area of the fibers, in a vertical compressive manner, a known mass load during a predetermined time;
once the load is released, capturing images in elevation, according to the same area, of the fibers subjected to the load, at predetermined time intervals;
treating the captured images framing the same zone of application of the load;
the images treated in the previous stage, for each time interval, are analyzed obtaining the area, in mm2, of each one of the two zones depicted in a different color, and;
determining the recovery index of the fibers subjected to an analysis based on the area occupied by the fibers before being subjected to the load and after the different predetermined time intervals, said index being determined by:
$$Recovery index ( \% ) , It = \frac{Area after releasing load ( mm 2 )}{Area without load ( mm 2 )} \times 100$$
determining the recovery rate of the fibers subjected to an analysis for which the curve of the recovery index is adjusted to a logarithmic mathematical function of the type f(x)=Aln(x)+B, as the function derivative (the slope) at the moment of releasing the load, the function being:
$${I}_{t} 〉 〉 A \times Ln ( t ) + B$$
$$VR ( t = 1 min ) = \frac{d ( It )}{d t} = A \times 1 / t ( \% \text{/} min )$$

2. A method for determining the recovery grade in artificial fiber carpets, according to claim 1, with the images treated and framed in the same zone of application of the load, relative to stage 7, further comprising:
carrying out a balance of the images increasing the contrast of the image defining the two zones of study relative to the zone of fibers and to the background present in a different color, and;
eliminating all glossiness from the fibers appearing in the background image;

3. A method for determining the recovery grade in artificial fiber carpets, according to claim 1, wherein the results of each captured image, at the different predetermined time intervals, allow obtaining how much and how fast various materials recover after being processed as artificial fibers sewn on a polymeric fabric.

4. The method of claim 3 wherein the fabric comprises artificial turf.
